(19) United States
(12) Patent Application Publication
(10) Pub. No.: US 2008/0106678 A1
(43) Pub. Date: May 8, 2008

(54) Color filter structure and displaying panel using the same and displaying method thereof

(75) Inventors: Po-Hsien Wang, Taichung City (TW); Hsuan-Yang Chen, Ji-an Township (TW); Chih-Chang Lai, Taiping City (TW)

Correspondence Address: RABIN & Berdo, PC, 1101 14TH STREET, NW, SUITE 500, WASHINGTON, DC, 20005, US

(73) Assignee: Wintek Corporation, Taichung County (TW)

(21) Appl. No.: 11/976,679

(22) Filed: Oct. 26, 2007

Related U.S. Application Data
(60) Provisional application No. 60/856,295, filed on Nov. 3, 2006.
(60) Provisional application No. 60/858,392, filed on Nov. 13, 2006.

(30) Foreign Application Priority Data
Aug. 21, 2007 (TW) 96130957

(51) Int. Cl. G02F 1/1335; G02B 5/22; G09G 5/02

(52) U.S. Cl. 349/108; 345/604; 359/891

(57) ABSTRACT

A color filter structure disposed in a displaying panel of a display device is provided. The color filter structure includes several filtering layers with at least four colors. The four colors are red, blue, a first color and a second color. The first color is between green and cyan. The second color is between green and yellow.

This application claims the benefits of U.S. provisional application Ser. No. 60/856,295, filed Nov. 3, 2006, U.S. provisional application Ser. No. 60/858,392, filed on Nov. 13, 2006 and Taiwan application Serial No. 096130957, filed Aug. 21, 2007, the subject matter of which is incorporated herein by reference.

### BACKGROUND OF THE INVENTION

1. Field of the Invention

The invention relates in general to a color filter structure and a displaying panel using the same and a displaying method thereof, and more particularly to a color filter structure capable of increasing the color saturation and a displaying panel using the same and a displaying method thereof.

2. Description of the Related Art

As a result of the features of thinness, lightweight and compactness, the application of a liquid crystal display (LCD) device is getting general and common. Basically, the LCD device is incorporated with a color filter with three basic colors namely, red, green and blue. As the LCD device with higher color saturation is expected, a new LCD device having a color filter with the fourth color is provided. The new LCD device can increase the color saturation as a result of the color filter with the four colors.

However, the new LCD device having the color filter with the four colors still faces the white balance problem. Referring to Table 1, a table containing the CIE chromaticity coordinates of the white display of a RGBY type LCD device and a RGBC type LCD device is illustrated.

TABLE 1

the CIE chromaticity
Coordinates of the
White Display

| | x | y | NTSC Ratio (%) |
|---|---|---|---|
| RGBY Type | 0.3462 | 0.3616 | 75.44 |
| RGBC Type | 0.2617 | 0.2925 | 75.63 |

Generally speaking, the CIE chromaticity coordinates of the white color is (0.33, 0.33). If the CIE chromaticity coordinates of the white display of a LCD device are closer to (0.33, 0.33), the LCD device has better white balance effect. As shown in Table 1, the CIE chromaticity coordinates (0.3462, 0.3616) of the white display of the RGBY type LCD device and the CIE chromaticity coordinates (0.33, 0.33) of the white color have differences. The comparison between the CIE chromaticity coordinates (0.2617, 0.2925) of the white display of the RGBC type LCD device and the CIE chromaticity coordinates (0.33, 0.33) of the white color also shows differences. Thus, both the RGBY type LCD device and the RGBC type LCD device have the white balance problem according to Table 1.

In Table 1, the NTSC ratio refers to the ratio of the color reproduction range of a LCD device to the range of the television system standard established by the National Television System Committee (NTSC). The television system standard is a range defined by the CIE chromaticity coordinates (0.67, 0.33), (0.21, 0.71) and (0.14, 0.08). The higher the NTSC ratio is, the closer to the range defined by NTSC the color reproduction range of a LCD device would be. As shown in Table 1, the NTSC ratio of the RGBY type LCD device is 75.44%, and the NTSC ratio of the RGBC type LCD device is 75.63%. The two NTSC ratios show that the color reproduction ranges of both the RGBY type LCD device and the RGBC type LCD device are inferior to the range of the television system standard established by NTSC.

Moreover, compared with a conventional RGB type LCD device, the RGBY type LCD device and the RGBC type LCD device both have one more sub-pixel, hence additional driving components, such as driving circuits or transistors, are required to be added. As a result, the manufacturing costs of the RGBY type LCD device and the RGBC type LCD device increase accordingly.

### SUMMARY OF THE INVENTION

The invention is directed to a color filter structure and a displaying panel using the same and a displaying method thereof. The color filter structure has filtering layers with four colors and the same widths, so that a display device equipped with the color filter structure is capable of displaying an image with higher color saturation and better white balance. In addition, the display device equipped with the color filter structure can display an image with higher color saturation without adding additional components such as driving circuits as a result of the performance of the displaying method.

According to a first aspect of the present invention, a color filter structure disposed in a displaying panel of a display device is provided. The color filter structure comprises a plurality of filtering layers with at least four colors comprising red, blue, a first color and a second color. The first color is between green and cyan. The second color is between green and yellow.

According to a second aspect of the present invention, a displaying panel disposed in a display device is provided. The displaying panel comprises a first substrate, a second substrate and a color filter structure. The second substrate is substantially disposed in parallel to the first substrate. The color filter structure is disposed between the first substrate and the second substrate. The color filter structure comprises a plurality of filtering layers with at least four colors comprising red, blue, a first color and a second color. The first color is between green and cyan. The second color is between green and yellow.

According to a third aspect of the present invention, a displaying method is provided. The displaying method comprises the following steps. Firstly, a display device is provided. A displaying panel of the display device comprises a color filter structure. The color filter structure comprises a plurality of rows each comprising a plurality of filtering layers with four colors arranged repetitively. The displaying panel further comprises a plurality of sub-pixels comprising a red sub-pixel, a blue sub-pixel, a first color sub-pixel and a second color sub-pixel. Next, image data is provided. The image data comprises three-color data values of the red sub-pixel, the blue sub-pixel and a green sub-pixel. Then, the grey level values of the red sub-pixel and the green sub-pixel of the three-color data values are calculated for transforming the three-color data values into four-color data values. The four-color data values comprise the grey level values of the red sub-pixel, the blue sub-pixel, the green sub-pixel and the second color sub-pixel.

The invention will become apparent from the following detailed description of the preferred but non-limiting embodiments. The following description is made with reference to the accompanying drawings.

### BRIEF DESCRIPTION OF THE DRAWINGS

FIG. 1 shows a displaying panel according to a preferred embodiment of the invention;

FIG. 2 shows the color filter structure in FIG. 1;

FIG. 3 is a CIE chromaticity coordinate diagram;

FIG. 4 shows a central pixel filter area and selective filter areas of the color filter structure in FIG. 2;

FIG. 5 shows the color filter structure in FIG. 4 having another pixel filter area;

FIG. 6 is a flowchart of a displaying method according to the present invention;

FIG. 7 shows of the image data;

FIG. 8 shows the four-color data values transformed from the three-color data values in FIG. 7;

FIG. 9A is a flowchart of the step 230 in FIG. 6;

FIG. 9B is the other flowchart of the step 230 in FIG. 6;

FIG. 10 shows the three-color data values at the third row in FIG. 7;

FIG. 11 shows the four-color data values transformed from the three-color data values in FIG. 10;

FIG. 12 shows the combination calculation of the first values and the second values selected from the four-color data values in FIG. 11; and

FIG. 13 shows the new grey level values and the actual grey level values for driving the sub-pixels.

### DETAILED DESCRIPTION OF THE INVENTION

Referring to FIG. 1, a displaying panel according to a preferred embodiment of the invention is shown. The present embodiment of the invention is exemplified by a displaying panel 500 disposed in a display device. The displaying panel 500 includes a first substrate 501, a second substrate 502 and a color filter structure 100. The second substrate 502 is disposed in parallel to the first substrate 501. The color filter structure 100 is disposed between the first substrate 501 and the second substrate 502.

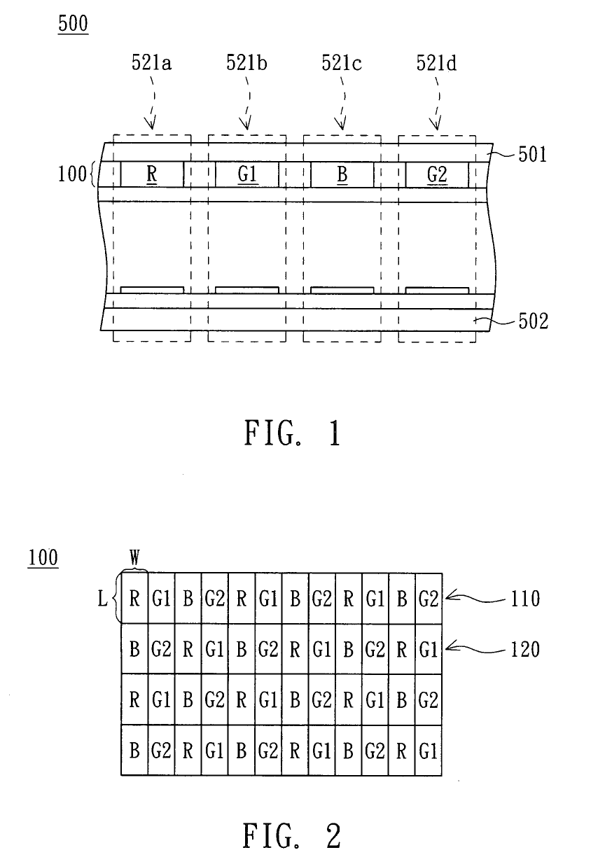

Referring to FIG. 2, the color filter structure in FIG. 1 is shown. The color filter structure 100 has several rows. Each of the rows includes several filtering layers with four colors arranged repetitively. If the light passes through one of the filtering layers, the color of the light would change into the color of the filtering layer. As a result, the display device can display a full-color image. In the present embodiment of the invention, the colors of the filtering layers are red R, blue B, a first color G1 and a second color G2. In addition, the widths W of the filtering layers are substantially the same, and the length L of each of the filtering layers is three times the width W of each of the filtering layers. As shown in FIG. 1, the filtering layers with the colors red R, the first color G1, blue B, and the second color G2 correspond to the sub-pixels 521a, 521b, 521c and 521d of the displaying panel 500 respectively.

As shown in FIG. 2, the arrangement of the filtering layers is exemplified by two neighboring rows 110 and 120. Each of the rows 110 and 120 includes the filtering layers with the colors red R, blue B, the first color G1 and the second color G2 arranged repetitively. Two neighboring filtering layers with two of the four colors are arranged alternately with another two neighboring filtering layers with the other two colors in rows. In other words, the two neighboring filtering layers with the two colors, for example, red R and the first color G1, in the row 110 are arranged alternately with another two neighboring filtering layers with the other two colors, that is, blue B and the second color G2, in the row 120.

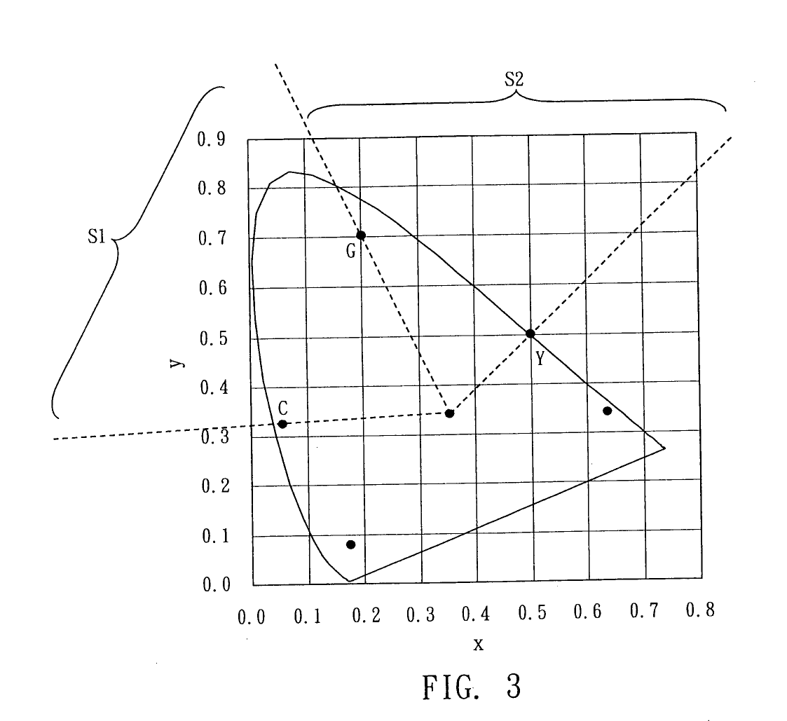

Referring to FIG. 3, a CIE chromaticity coordinate diagram is shown. The CIE chromaticity coordinate diagram in FIG. 3 was established in 1931, and the chromatic characteristics of each color are shown in the CIE chromaticity coordinate diagram. In the present embodiment of the invention, the first color G1 is between green and cyan, and the first color G1 is preferably within a chromatic range S1 between pure green (designated by G in FIG. 3) and pure cyan (designated by C in FIG. 3). The second color G2 is between green and yellow, and the second color G2 is preferably within a chromatic range S2 between pure green (G) and pure yellow (designated by Y in FIG. 3). Thus, the display device equipped with the color filter structure 100 can display an image with higher color saturation and better white balance. Referring to Table 2, a table containing the CIE chromaticity coordinates of the white display of the display device equipped with the color filter structure 100 is shown.

TABLE 2

| | |
|---|---|
| the CIE | |
| Chromaticity Coordinates | |
| of the White Display | NTSC |

| | x | y | ratio (%) |
|---|---|---|---|
| the Display Device | 0.3059 | 0.3295 | 100.11 |
| of the Present | | | |
| Embodiment of the | | | |
| Invention | | | |

As shown in Table 2, the CIE chromaticity coordinates of the white display of the display device are (0.3059, 0.3295) which are apparently close to the CIE chromaticity coordinates (0.33, 0.33) of the white color. In addition, the NTSC ratio of the display device is 100.11%. Compared with the RGBY type display device and the RGBC type display device mentioned in Table 1, the display device of the present embodiment of the invention equipped with the color filter structure 100 has better white balance, and the color reproduction range is closer to the range of the television system standard established by NTSC. The color characteristics of the first color G1 and the second color G2 can be defined according to the hue angles in the chromaticity coordinates system (CIE L*u*v*) established in 1976 as well. The hue angle of the first color G1 ranges from 140 to 220 degrees, and the hue angle of the second color G2 ranges from 90 to 140 degrees. The hue angle of the first color G1 and that of the second color G2 are transformed from the coordinates x and y in the CIE chromaticity coordinate diagram in FIG. 3.

When the displaying panel 500 (as shown in FIG. 1) is driven, several central pixel filter areas are defined according a display image. Each central pixel filter area is constituted by three neighboring filtering layers. Referring to FIG. 4, a central pixel filter area and selective filter areas of the color filter structure in FIG. 2 are shown. Each of the filtering layers corresponds to a sub-pixel. A central pixel filter area 130, for example, of the color filter structure 100 includes three neighboring filtering layers 130p1, 130p2 and 130p3. The colors of the filtering layers 130p1, 130p2 and 130p3 are the second color G2, red R and the first color G1 respectively. The central pixel filter area 130 is surrounded by the selective filter areas 130r, 130l, 130t and 130b. The colors of the selective filter areas 130r, 130l, 130t and 130b are blue B excluded by the central pixel filter area 130. The central pixel filter area 130 is merely an example of the present embodiment of the invention. Alternatively, the color filter structure 100 has another central pixel filter area formed by other three neighboring filtering layers. In this case, the color filter structure 100 has other selective filter areas positioned around the central pixel filter area.

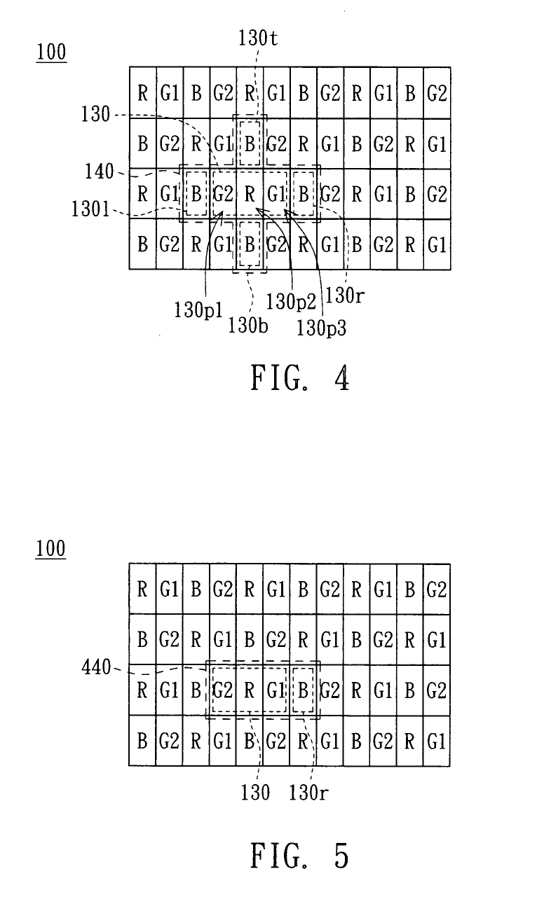

The color filter structure 100 according to the invention has a pixel filter area 140 formed by the central pixel filter area 130 and the selective filter areas 130r, 130l, 130t, 130b. Alternatively, the pixel filter area can be formed by the central pixel filter area and any number of the selective filter areas positioned around the central pixel filter area. For instance, referring to FIG. 5, the color filter structure in FIG. 4 having another pixel filter area is shown. As shown in FIG. 5, the pixel filter area 440 of the color filter structure 100 has the central pixel filter area 130 and only one selective filter area 130r positioned at the right side of the central pixel filter area 130. In the present embodiment of the invention, the displaying method is related to the definition of the pixel filter area of the color filter structure.

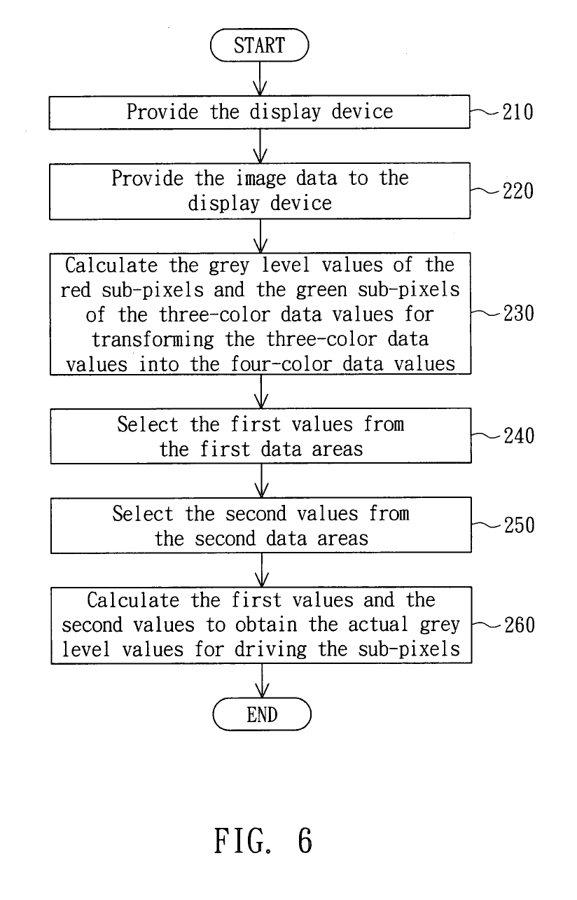

Referring to FIG. 6, a flowchart of a displaying method according to the present invention is shown. As the displaying method is utilized, the display device equipped with the color filter structure 100 can display an image with higher color saturation and better white balance without adding any additional components such as driving circuits. The displaying method includes the following steps. Firstly, as shown in FIG. 6, the displaying method begins at the step 210, the display device is provided. The displaying panel of the display device includes the color filter structure 100 as shown in FIG. 5. As above-mentioned, the color filter structure 100 has the rows each including the filtering layers with the four colors arranged repetitively. The widths of the filtering layers are the same. Each of the filtering layers corresponds to a sub-pixel, and the color of each of the sub-pixels corresponds to the color of each of the filtering layer. Thus, the sub-pixels are the red sub-pixels, the blue sub-pixels, the first color sub-pixels and the second color sub-pixels. The color filter structure 100 (as shown in FIG. 5) has the pixel filter area 440 including the central pixel filter area 130 and the selective filter area 130r.

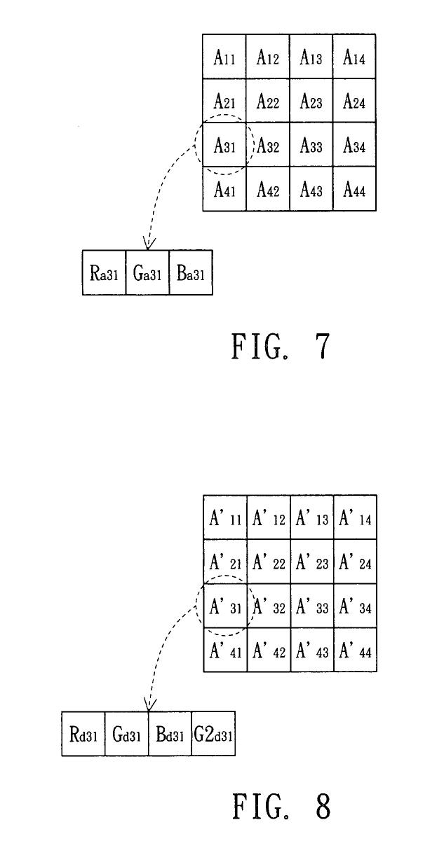

Next, as shown in FIG. 6, in the step 220, the image data is provided to the display device. Referring to FIG. 7, the image data is shown. The image data includes three-color data values Aᵢⱼ of the red sub-pixels, the blue sub-pixels and the green sub-pixels (i, j=1˜4 correspond to the structure shown in FIG. 5). Rₐᵢⱼ, Gₐᵢⱼ and Bₐᵢⱼ are the grey level values of the three-color data values Aᵢⱼ of the red sub-pixels, the green sub-pixels and the blue sub-pixels respectively. As shown in FIG. 7, the first three-color data value A₃₁ in the third row includes the grey level values Rₐ₃₁, Gₐ₃₁ and Bₐ₃₁ of the red sub-pixel, the green sub-pixel and the blue sub-pixel, for example.

Then, as shown in FIG. 6, in the step 230, the grey level values Rₐᵢⱼ and Gₐᵢⱼ of the three-color data values Aᵢⱼ of the red sub-pixels and the green sub-pixels are calculated for transforming the three-color data values Aᵢⱼ into the four-color data values A′ᵢⱼ. Referring to FIG. 8, the four-color data values transformed from the three-color data values in FIG. 7 are shown. The transformed four-color data values A′ᵢⱼ include the grey level values of the red sub-pixels, the green sub-pixels, the blue sub-pixels and the second color sub-pixels respectively designated by R_{diJ}, G_{dij}, B_{dij} and G2_{dij}. For example, after transforming the three-color data value A₃₁ in FIG. 7, the first four-color data value A′₃₁ in the third row in FIG. 8 includes the grey level values R_{d31}, G_{d31}, B_{d31} and G2_{d31} of the red sub-pixel, the green sub-pixel, the blue sub-pixel and the second color sub-pixel respectively.

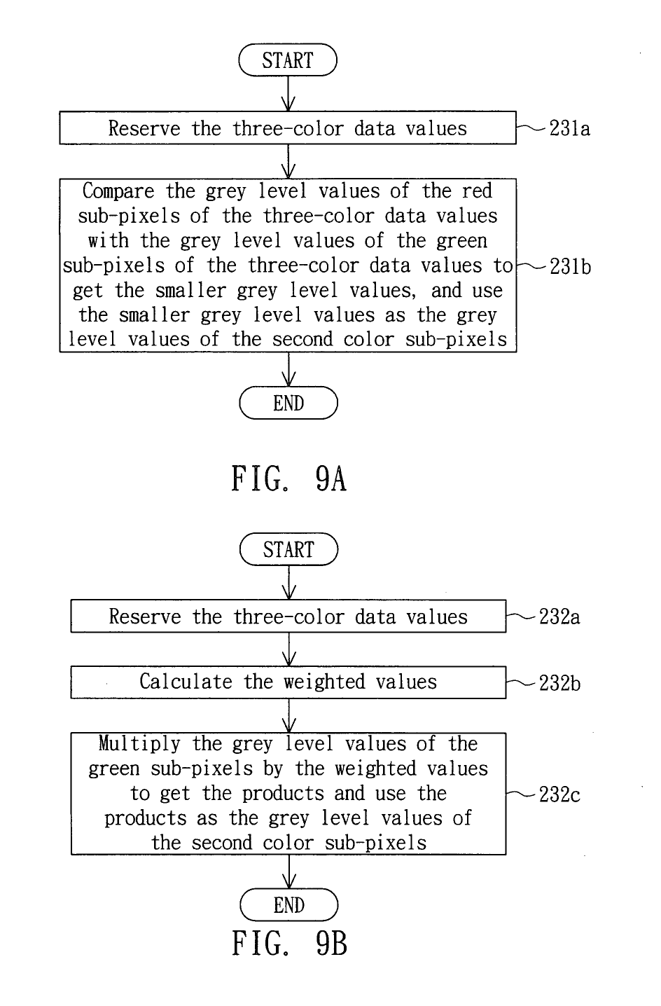

The step 230 is further elaborated. The grey level values R_{dij} of the red sub-pixels and the grey level values G_{dij} of the green sub-pixels are calculated for transforming the three-color data values Aᵢⱼ into the four-color data values A′ᵢⱼ. The step 230 of transforming the three-color data values Aᵢⱼ into the four-color data values A′ᵢⱼ can be performed according to either a method shown in FIG. 9A or the other method shown in FIG. 9B.

Referring to FIG. 9A, a flowchart of the step 230 in FIG. 6 is shown. Firstly, in the step 231a, the grey level values Rₐᵢⱼ, Bₐᵢⱼ, and Gₐᵢⱼ, of the red sub-pixels, the blue sub-pixels, and the green sub-pixels of the three-color data values Aᵢⱼ are reserved. In other words, R_{dij}=Rₐᵢⱼ, G_{dij}=Gₐᵢⱼ and B_{dij}=Bₐᵢⱼ. For example, as shown in FIG. 7 and FIG. 8, R_{d31}=Rₐ₃₁, G_{d31}=Gₐ₃₁ and B_{d31}=Bₐ₃₁. Next, in the step 231b, the grey level values Rₐᵢⱼ and Gₐᵢⱼ of the red sub-pixels and the green sub-pixels of the three-color data values are compared to get the smaller grey level values and the smaller grey level values are used as the grey level values G2_{dij} of the second color sub-pixels. In other words, G2_{dij}=min (Rₐᵢⱼ, Gₐᵢⱼ). This is one of the methods for transforming the three-color data values Aᵢⱼ into the four-color data values A′ᵢⱼ.

Referring to FIG. 9B, the other flowchart of the step 230 in FIG. 6 is shown. The flowchart in FIG. 9B is the other method for transforming the three-color data values Aᵢⱼ into the four-color data values A′ᵢⱼ. Firstly, in the step 232a, the grey level values Rₐᵢⱼ, Bₐᵢⱼ and Gₐᵢⱼ of the red sub-pixels, the blue sub-pixels and the green sub-pixels of the three-color data values Aᵢⱼ are reserved. In other words, R_{dij}=Rₐᵢⱼ, G_{dij}=Gₐᵢⱼ and B_{dij}=Bₐᵢⱼ. Next, in the step 232b, the weighted values Sᵢⱼ are calculated according to the expression Sᵢⱼ=C1ᵢⱼ/(C1ᵢⱼ+C2ᵢⱼ). C1ᵢⱼ and C2ᵢⱼ are respectively the grey level values Gₐᵢⱼ and Rₐᵢⱼ of the green sub-pixels and the red sub-pixels of the three-color data values Aᵢⱼ. That is, C1ᵢⱼ=Gₐᵢⱼ and C2ᵢⱼ=Rₐᵢⱼ. Then, in the step 232c, the grey level values C1ᵢⱼ of the green sub-pixels are multiplied by the weighted values Sᵢⱼ to get the products and the products are used as the grey level values G2_{dij} of the second color sub-pixels. The calculation in the step 232c is expressed as G2_{dij}=Sᵢⱼ×C1ᵢⱼ. The three-color data values Aᵢⱼ in FIG. 7 can be transformed into the four-color data values A′ᵢⱼ in FIG. 8 by the step 230 utilizing either the method disclosed in FIG. 9A or the method disclosed in FIG. 9B.

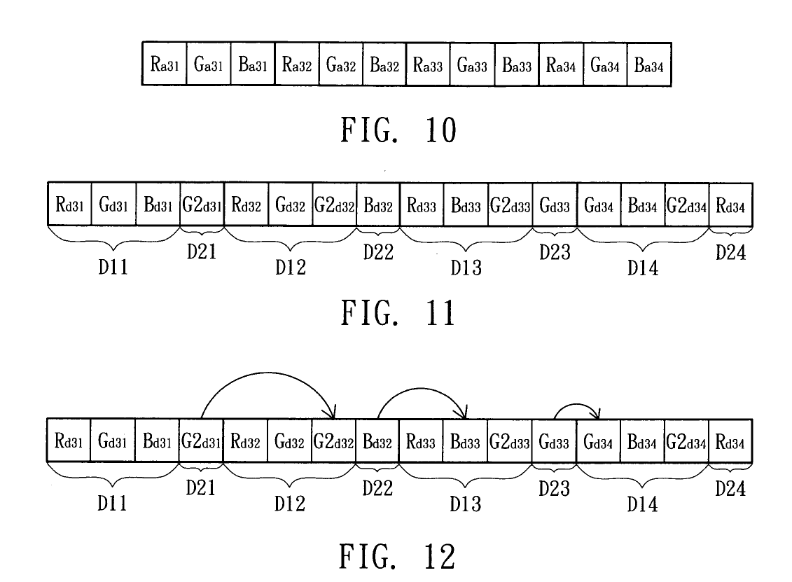

FIG. 10 shows the three-color data values at the third row in FIG. 7. FIG. 11 shows the four-color data values transformed from the three-color data values in FIG. 10. The displaying method according to the invention is exemplified by the three-color data values A₃ⱼ in the third row in FIG. 7 and the transformed four-color data values A′₃ⱼ.

As shown in FIG. 10, the three-color data values A₃ⱼ in the third row in FIG. 7 include the grey level values Rₐ₃ⱼ of the red sub-pixels, the grey level values Bₐ₃ⱼ of the blue sub-pixels and the grey level values Gₐ₃ⱼ of the green sub-pixels. The four-color data values A′₃ⱼ as shown in FIG. 11 are obtained after the step 230 in FIG. 6 is performed. Any of the four-color data values A′₃ⱼ includes a first data area and a second data area, and the four-color data values A′₃ⱼ include the first data areas D11, D12, D13 and D14 and the second data areas D21, D22, D23 and D24. Each of the first data areas D11, D12, D13 and D14 are the data area formed by the grey level values of three neighboring sub-pixels. The grey level values of the second data areas are the grey level values excluded by the first data areas. Let the four-color data value A′₃₁ in FIG. 8 be taken as an example, the four color value A′₃₁ includes two data areas: one is the first data area D11 and the other one is the second data area D21. The first data area D1 includes the grey level value R_{d31} of the red sub-pixel, the grey level value G_{d31} of the green sub-pixel and the grey level value B_{d31} of the blue sub-pixel, and the second data area D21 includes the grey level value G2_{d31} of the second color sub-pixel. In addition, let the four-color data value A′₃₂ in FIG. 8 be taken as the other example, the four-color data value A′₃₂ includes the first data area D12 and the second data area D22. The first data area D12 includes the grey level value R_{d32} of the red sub-pixel, the grey level value G_{d32} of the green sub-pixel and the grey level value G2_{d32} of the second color sub-pixel, and the second data area D22 includes the grey level value B_{d32} of the blue sub-pixel.

Next, as shown in FIG. 6 and FIG. 11, in the step 240, the first values are selected from the first data areas D11, D12, D13 and D14 respectively. The first values in each of the first areas include the grey level values of the three neighboring sub-pixels corresponding to the central pixel filter area. That is, the first values in each of the first data areas D11, D12, D13 and D14 include the grey scale values of the three neighboring sub-pixels corresponding to the three neighboring filtering layers (central pixel filter areas) in the third row in FIG. 5. Take the first data area D12 as an example, the first values in the first data area D12 are the grey scale values R_{d32}, G_{d32} and G2_{d32} of the three neighboring sub-pixels corresponding to the central pixel filter area 130 in FIG. 5.

Then, as shown in FIG. 6 and FIG. 11, in the step 250, the second values are selected from the second data areas D21, D22, D23 and D24 respectively. Take the pixel filter area 440 of the central pixel filter area 130 in FIG. 5 as an example, the second value is B_{d32}, because the blue sub-pixel corresponds to the selective filter area 130r excluded by the central pixel filter area 130.

In other words, in the step 240 and the step 250, when a central pixel filter area includes a red sub-pixel, a blue sub-pixel and a green sub-pixel, the first values in the first data area are the grey level values of the red sub-pixel, the blue sub-pixel and the green sub-pixel. The second value in the second data area is the grey level value of the second color sub-pixel. When a central pixel filter area includes a second color sub-pixel and any two of a red sub-pixel, a blue sub-pixel and a green sub-pixel, for example, the red sub-pixel and the blue sub-pixel, the first values in the first data area are the grey level value of the second color sub-pixel, the red sub-pixel and the blue sub-pixel. The second value in the second data area is the grey level value of the sub-pixel excluded by the first data area, that is, the grey level value of the green sub-pixel.

Then, as shown in FIG. 6, in the step 260, the first values and the second values are calculated to obtain the actual grey level values Rₚᵢⱼ, Gₚᵢⱼ, Bₚᵢⱼ and G2ₚᵢⱼ of the sub-pixels for driving the sub-pixels. In the present embodiment of the invention, a second value selected from a second data area in a pixel filter area is combined with a first value selected from another pixel filter area at the right side of the pixel filter area having the above-mentioned second value. An example would be expressed as follows.

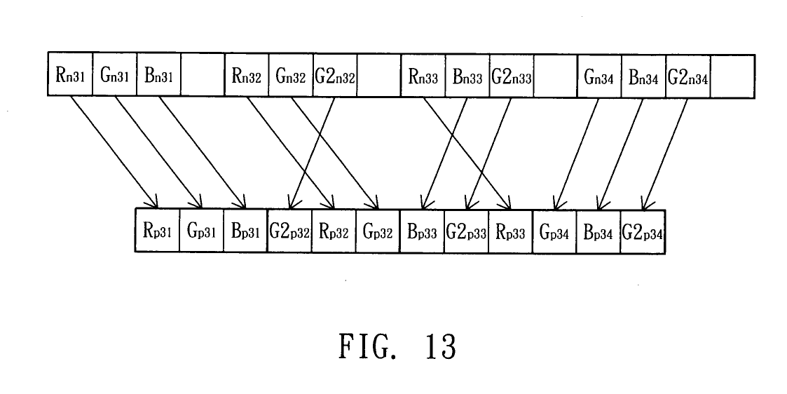

Referring to FIG. 12, the combination calculation of the first values and the second values selected from the four-color data values in FIG. 11 is shown. As indicated by the arrow sings in FIG. 12, the second values G2_{d31}, B_{d32} and G_{d33} are respectively combined with the first values G2_{d32}, B_{d33} and G_{d34}. Let the first data area D12 be taken as an example. As the second value G2_{d31} in the second data area D21 is shared to the first data area D12, the first value G2_{d32} is adjusted accordingly. The grey level values R_{d32} and G_{d32} in the first data area D12 does not need to be combined with other second values, so the new grey level values are expressed as Rₙ₃₂=R_{d32} and Gₙ₃₂=G_{d32}. Alternatively, G2ₙ₃₂ can be the average or the minimum of G2_{d32} and G2_{d31}. As B_{d32} is the grey level value of the sub-pixel in the second data area D22, B_{d32} is also the second value. As the sharing is towards the right direction, B_{d32} is combined with the first value B_{d33} in the first data area D13. Similarly, a new grey level value Bₙ₃₃ can be the average or the minimum of B_{d32} and B_{d33}. The displaying method is exemplified by the data of the pixel filter area 440 in the third row in FIG. 5, and the calculation of other data can be performed in the same manner.

The displaying method is related to the definition of the pixel filter area of the color filter structure, so the above steps of the displaying method performs the data processing according to the definition of the pixel filter area 440 in FIG. 5 as an example. If a pixel filter area is defined as the pixel filter area 140 in FIG. 4, the second value in the pixel filter area 140 is combined with first values in the pixel filter areas at the top, bottom, right and left of the pixel filter area 140.

Referring to FIG. 13, the new grey level values and the actual grey level values for driving the sub-pixels are shown. As shown in FIG. 13, the grey level values in the top row are formed by the new grey level values. The blanks in the top row are the positions of the second data areas in FIG. 12. The second values in the second data areas are shared to the first values in the first data areas to combine together, so the second data areas are denoted by the blanks in the top row in FIG. 13. The bottom row in FIG. 13 is formed by the grey level values rearranged from the grey level values in the top row in FIG. 13, and the grey level values in the bottom row are the actual grey level values Rₚᵢⱼ, Gₚᵢⱼ, Bₚᵢⱼ and G2ₚᵢⱼ for driving the sub-pixels. The arrangement of the actual grey level values Rₚᵢⱼ, Gₚᵢⱼ, Bₚᵢⱼ and G2ₚᵢⱼ corresponds to the arrangement of the filtering layers of the color filter structure 100 in FIG. 5. That is, the actual grey level values in FIG. 13 are used for driving the sub-pixels corresponding to the third row of the color filter structure 100. The actual grey level values Rₚᵢⱼ, Bₚᵢⱼ and G2ₚᵢⱼ are used for driving the red sub-pixels, the blue sub-pixels and the second color sub-pixels respectively. The actual grey level value Gₚᵢⱼ of the green sub-pixels are used for driving the first color sub-pixels.

In the present embodiment of the invention, the actual grey level values in the bottom row in FIG. 13 are used for driving the sub-pixels corresponding to the filtering layers in the third row of the color filter structure 100 in FIG. 5. According to the displaying method of the present embodiment of the invention, the actual grey level values for driving other sub-pixels to display a display image can be obtained as well.

According to the color filter structure and the displaying panel using the same and the displaying method thereof disclosed in the above embodiment of the invention, the displaying panel of the display device displays an image with higher color saturation and better white balance. Specifically speaking, the color filter structure of the present embodiment of the invention has the filtering layers with four colors arranged in a particular way, and the filtering layers have the same widths. As a result, it not only increases the NTSC ratio of the display device, but the CIE chromaticity coordinates of the white display of the display device are also closer to the CIE chromaticity coordinates of the white color. Besides, the displaying method enables the display device to display an image with higher color saturation and better white balance without adding additional components such as driving circuits, so that the manufacturing costs would decrease.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A color filter structure disposed in a displaying panel of a display device, the color filter structure comprising:
a plurality of filtering layers with at least four colors comprising red, blue, a first color and a second color, wherein the first color is between green and cyan, and the second color is between green and yellow.

2. The color filter structure according to claim 1, wherein the hue angle of the first color ranges from 140 to 220 degrees and the hue angle of the second color ranges from 90 to 140 degrees.

3. The color filter structure according to claim 1, wherein the widths of the filtering layers are substantially the same, and the length of each of the filtering layers is three times the width of each of the filtering layers.

4. The color filter structure according to claim 1, wherein the color filter structure has a plurality of rows each comprising the filtering layers with the four colors arranged repetitively, and two neighboring filtering layers with two of the four colors are arranged alternately with another two neighboring filtering layers with the other two colors in rows.

5. The color filter structure according to claim 4, wherein the color filter structure has at least one central pixel filter area comprising three neighboring filtering layers.

6. The color filter structure according to claim 5, wherein the color filter structure has at least one selective filter area positioned around the central pixel filter area, and the color of the selective filter area is the color excluded by the central pixel filter area.

7. The color filter structure according to claim 6, wherein the color filter structure has a plurality of selective filter areas, and a pixel filter area is constituted by at least one of the selective filter areas and the central pixel filter area.

8. A displaying panel disposed in a display device, the displaying panel comprising:
a first substrate;
a second substrate substantially disposed in parallel to the first substrate; and
a color filter structure disposed between the first substrate and the second substrate, wherein the color filter structure comprises:
a plurality of filtering layers with at least four colors comprising red, blue, a first color and a second color, wherein the first color is between green and cyan, and the second color is between green and yellow.

9. The displaying panel according to claim 8, wherein the hue angle of the first color ranges from 140 to 220 degrees and the hue angle of the second color ranges from 90 to 140 degrees.

10. The displaying panel according to claim 8, wherein the widths of the filtering layers are substantially the same, and the length of each of the filtering layers is three times the width of each of the filtering layers.

11. The displaying panel according to claim 8, wherein the color filter structure has a plurality of rows each comprising the filtering layers with the four colors arranged repetitively, and two neighboring filtering layers with two of the four colors are arranged alternately with another two neighboring filtering layers with the other two colors in rows.

12. The displaying panel according to claim 11, wherein the color filter structure has at least one central pixel filter area comprising three neighboring filtering layers.

13. The displaying panel according to claim 12, wherein the color filter structure has at least one selective filter area positioned around the central pixel filter area, and the color of the selective filter area is the color excluded by the central pixel filter area.

14. The displaying panel according to claim 13, wherein the color filter structure has a plurality of selective filter areas, and a pixel filter area is constituted by at least one of the selective filter areas and the central pixel filter area.

15. A displaying method, comprising:
(a) providing a display device, wherein a displaying panel of the display device comprises a color filter structure comprising a plurality of rows each comprising a plurality of filtering layers with four colors arranged repetitively, the displaying panel further comprises a plurality of sub-pixels comprising a red sub-pixel, a blue sub-pixel, a first color sub-pixel and a second color sub-pixel;
(b) providing image data comprising three-color data values of the red sub-pixel, the blue sub-pixel and a green sub-pixel; and
(c) calculating the grey level values of the red sub-pixel and the green sub-pixel of the three-color data values for transforming the three-color data values into four-color data values comprising the grey level values of the red sub-pixel, the blue sub-pixel, the green sub-pixel and the second color sub-pixel.

16. The displaying method according to claim 15, wherein the color of the first color sub-pixel is between green and cyan, and the color of the second color sub-pixel is between green and yellow.

17. The displaying method according to claim 16, wherein the hue angle of the color of the first color sub-pixel ranges from 140 to 220 degrees and the hue angle of the color of the second color sub-pixel ranges from 90 to 140 degrees.

18. The displaying method according to claim 15, wherein the step (c) comprises:
(c1) reserving the three-color data values; and
(c2) comparing the grey level value of the red sub-pixel of the three-color data values with the grey level value of the green sub-pixel of the three-color data values to get a smaller grey level value, and using the smaller grey level value as the grey level value of the second color sub-pixel.

19. The displaying method according to claim 15, wherein the step (c) comprises:
(c1) reserving the three-color data values;
(c2) calculating a weighted value S according to the expression S═C1/(C1+C2), wherein C1 and C2 are respectively the grey level values of the green sub-pixel and the red sub-pixel of the three-color data values; and
(c3) Multiplying the grey level value C1 of the green sub-pixel by the weighted value S to get a product and using the product as the grey level value of the second color sub-pixel.

20. The displaying method according to claim 15, wherein the color filter structure has at least one central pixel filter area and at least one selective filter area, the central pixel filter area comprises three neighboring filtering layers, the selective filter area is positioned around the central pixel filter area, and the color of the selective filter area is the color excluded by the central pixel filter area.

21. The displaying method according to claim 20, wherein after the step (c), the displaying method further comprises:
(d) selecting a first value in a first data area, wherein the first data area is formed by the grey level values of three neighboring sub-pixels corresponding to the central pixel filter area and the first value comprises one of the grey level values of the three neighboring sub-pixels in the first data area;
(e) selecting a second value in a second data area, wherein the second area is formed by the grey level value of the sub-pixel corresponding to the selective filter area and the second value comprises the grey level value of the sub-pixel in the second data area; and
(f) calculating the first value and the second value to obtain an actual grey level value for driving the sub-pixel.

22. The displaying method according to claim 21, wherein when the central pixel filter area corresponds to the red sub-pixel, the blue sub-pixel and the green sub-pixel, the first value is one of the grey level values of the three-color data values.

23. The displaying method according to claim 21, wherein when the central pixel filter area corresponds to the second color sub-pixel and any two of the red sub-pixel, the blue sub-pixel and the green sub-pixel, the first value is one of the grey level value of the second color sub-pixel and the grey level values of the two sub-pixels.

24. The displaying method according to claim 21, wherein the grey level value of the sub-pixel of the second data area is the grey value of the sub-pixel excluded by the first data area.

25. The displaying method according to claim 15, wherein two neighboring sub-pixels with two of the four colors are arranged alternately with another two neighboring sub-pixels with the other two colors in rows.
